(19) United States
(12) Patent Application Publication
(10) Pub. No.: US 2017/0061559 A1
(43) Pub. Date: Mar. 2, 2017

(54) Control Framework Fostering Compliant Integration of Data

(71) Applicant: SAP SE, Walldorsf (DE)

(72) Inventors: Christoph Ehrhardt, Mannheim (DE); Boris Aljancic, Mannheim (DE); Frank Barthel, Mnnheim (DE)

(21) Appl. No.: 14/842,568

(22) Filed: Sep. 1, 2015

(51) Int. Cl. G06Q 50/18; G06Q 50/00; G06F 21/62

(52) U.S. Cl. CPC G06Q 50/18; G06F 21/6254; G06Q 50/01

(57) ABSTRACT

Embodiments provide a control framework that fosters the integration of information handling systems with data from internal and/or external sources, compliant with various requirements (e.g., regulatory-based, arising from network terms and conditions). A configuration platform addresses data protection and privacy concerns, allowing flexible definition and application of rules. Rules may consider factors such as data source, national jurisdiction, and purpose of the end user. The rules may address whether/how consent is to be obtained, possible anonymization of personal data, and other issues. Once defined, the framework rules govern processing personal data obtained from internal and/or external sources in a legally compliant manner. Rules and/or configurations may be stored centrally (e.g., locally on premises, remotely in the cloud), with each business process requesting a particular valid rule set when processing personal data. A configuration interface allows the enterprise to dynamically comply with data privacy obligations supported by a (context-sensitive) rules engine.

### BACKGROUND

Unless otherwise indicated herein, the approaches described in this section are not prior art to the claims in this application and are not admitted to be prior art by inclusion in this section.

Embodiments relate to control frameworks for business systems, and in particular, to a customizable control framework to provide legal compliance for social media integration into business systems.

Today, consumers are increasingly digitally connected and socially networked together. To better understand consumer demand and behavior, enterprises seek to connect their business systems with external social networks, for example FACEBOOK and others.

In addition to such public social networks, consumers may also participate in their own private, self-operated social networks. Users may thus also seek to integrate interactions with such private social networks internally within a company. An example of this could be a salesperson's integrating contact information from a private network, into Customer Relationship Management (CRM) software of an enterprise to which she currently belongs.

Such storage and processing of personal data, however, may implicate a variety of privacy laws and regulations in effect within various jurisdictions. For example, there are many country and industry specific legal regulations.

Also, each social network has its own terms and conditions (T&Cs). Examples of legal requirements imposed by national laws and T&Cs of individual networks, can govern activities including but not limited to, granting of user consent, rendering personal data anonymous, and deletion of personal data.

Given the above, it is currently difficult for an enterprise to easily configure a business system or particular business processes to comply with such a multitude of restrictions on the storage and processing of personal data originating from internal and external sources.

### SUMMARY

Embodiments provide a control framework that fosters the integration of information handling systems with data from internal and/or external sources, compliant with various legal requirements (e.g., regulatory-based, arising from network T&C's). A configuration platform addresses data protection and privacy concerns, allowing flexible definition and application of rules. Rules may consider factors such as data source, national jurisdiction, and purpose of the end user. The rules may address whether/how consent is to be obtained, possible anonymization of personal data, and other issues.

Rules and/or configurations may be stored centrally (e.g., locally on premises, remotely in the cloud), with each business process requesting a particular valid rule set when processing personal data. A configuration interface allows the enterprise to dynamically comply with data privacy obligations supported by a (context-sensitive) rules engine.

Once defined, framework rules govern processing of personal data obtained from internal and/or external sources in a legally compliant manner. Rules and/or configurations may be stored centrally (e.g., locally on premises, or remotely in the cloud), with each business process requesting a particular valid rule set when processing personal data.

A configuration interface allows the enterprise to dynamically comply with data privacy obligations supported by a (context-sensitive) rules engine. Where appropriate, the framework can implement context-controlled user interaction.

An embodiment of a computer-implemented method comprises an engine receiving data and associated contextual information, from a user within an enterprise. The engine processes the data and the associated contextual information according to a rule. Based upon execution of the rule, the engine integrates the data for storage within the enterprise compliant with a legal obligation.

An embodiment of a non-transitory computer readable storage medium embodies a computer program for performing a method comprising an engine receiving personal data and associated contextual information, from a user within an enterprise. The engine processes the personal data of an individual and the associated contextual information according to a rule. The engine solicits from the individual, consent to store the personal data. Based upon execution of the rule, the engine integrating the personal data for storage within the enterprise compliant with a legal obligation relating to privacy.

An embodiment of a computer system comprises one or more processors and a software program executable on said computer system. The software program is configured to cause an in-memory database engine to receive data and associated contextual information, from a user within an enterprise, and process the data and the associated contextual information according to a rule. Based upon execution of the rule, the software program is configured to integrate the data for storage within the enterprise at a data center compliant with a legal obligation arising from a law of a jurisdiction in which the data center resides.

In certain embodiments the data comprises personal data, and the legal obligation relates to privacy.

According to some embodiments, the data is integrated for storage in an anonymous form.

In various embodiments the associated contextual information comprises a country, and the legal obligation arises from a law of the country.

In particular embodiments the associated contextual information comprises a client.

In certain embodiments the associated contextual information identifies a source of the data.

In some embodiments the source is external to the enterprise.

In various embodiments the source internal to the enterprise.

According to particular embodiments the rule governs modification of the data for integration.

The following detailed description and accompanying drawings provide a better understanding of the nature and advantages of embodiments.

### BRIEF DESCRIPTION OF THE DRAWINGS

FIG. 1 shows a simplified view of a system according to an embodiment.

FIG. 2 shows a simplified block diagram illustrating a plurality of input data from different sources, integrated in various ways by a control framework according to an embodiment.

FIG. 3 shows an example of a table of a configuration framework for data privacy related topics.

FIG. 4 is a simplified process flow according to an embodiment.

FIG. 5 illustrates hardware of a special purpose computing machine configured to provide a control framework for compliant integration of internal and/or external data according to an embodiment.

FIG. 6 illustrates an example computer system.

### DETAILED DESCRIPTION

Described herein are control frameworks for compliant integration of internal and/or external data in business systems. In the following description, for purposes of explanation, numerous examples and specific details are set forth in order to provide a thorough understanding of the present invention. It will be evident, however, to one skilled in the art that embodiments of the present invention as defined by the claims may include some or all of the features in these examples alone or in combination with other features described below, and may further include modifications and equivalents of the features and concepts described herein.

Embodiments relate to a control framework fostering integration of internal/external data with information handling systems, compliant with various regulatory requirements. Particular embodiments offer a configuration platform addressing key requirements pertaining to data protection and privacy considerations, allowing for the flexible establishment and application of rules. Such rules may consider factors including but not limited to the data source (e.g., FACEBOOK), national jurisdiction, and purpose of the end user. Thus for a particular data source (e.g., FACEBOOK) and country, embodiments may define rules affecting the ability of a business process to store and/or delete personal/private data. The rules may address whether/how consent is to obtained, possible anonymization of personal data, and other issues relating to data handling.

Once defined, the rules of the framework govern processing personal data obtained from internal/external sources in a legally compliant manner. Rules and/or configurations may be stored centrally (e.g., locally on the premises, or remotely in the cloud), with each business process requesting a particular valid rule set when processing personal data.

A configuration interface allows the enterprise to dynamically comply with data privacy obligations supported by a (context-sensitive) rules engine. Where appropriate, the framework can implement context-controlled user interaction. For example, a pop-up window may be displayed for the purpose of raising user awareness, calling for manual acceptance as an active interaction before certain business processes can be executed.

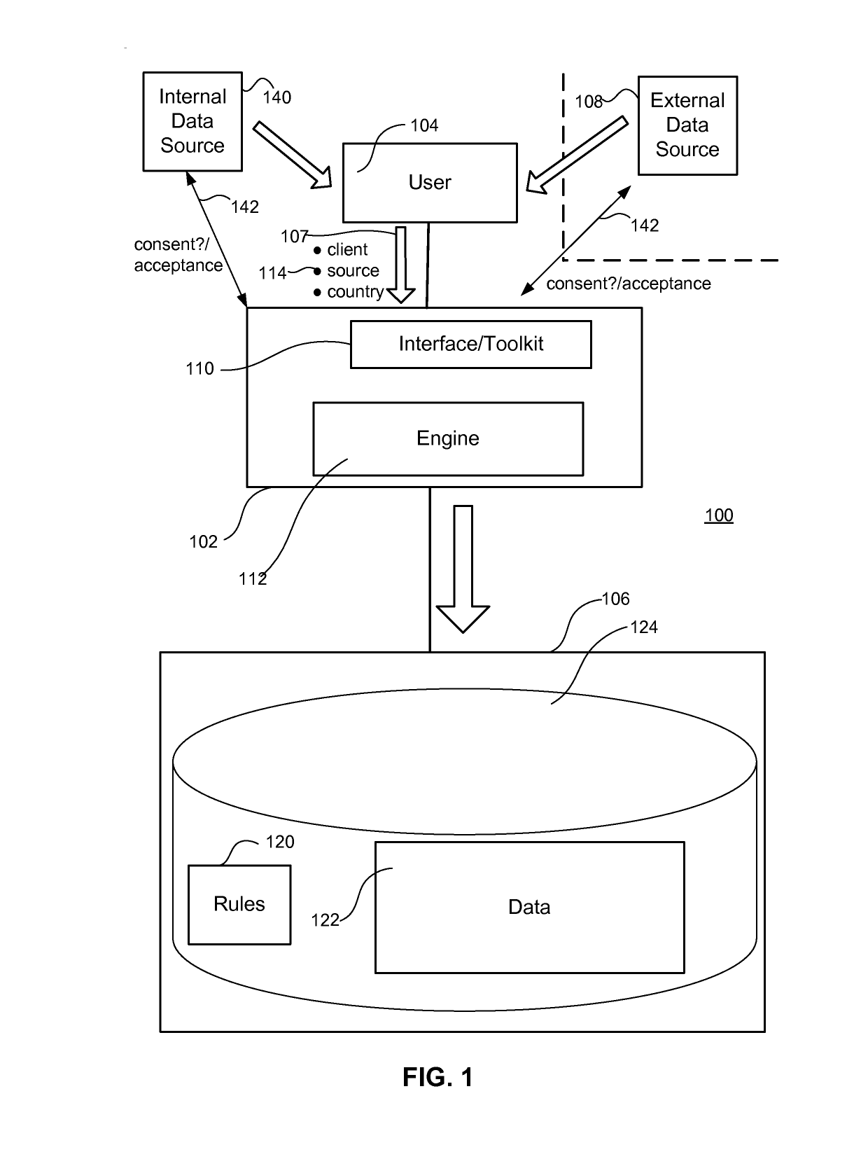

FIG. 1 presents a simplified view of a system 100 according to an embodiment. In particular, a compliance control framework 102 is positioned between a user 104 and an underlying data storage mart 106.

The user is configured to receive data 107 from one or more data sources. Shown here is a data source 108 external to an enterprise at which a user is employed. Examples of such external data sources can comprise, for example, the following:
public social networks;
private social networks;
blogs;
Application Program Interfaces (APIs) of third party data providers/data harvesters; and
others (e.g., as accessible off of the internet).

The user seeks to integrate the data into a business system within the enterprise. Accordingly, she forwards that data to the framework 102.

The framework includes an interface 110 configured to receive the data from the user. The interface comprises a toolkit allowing user/profile/role specific customization through an administrator user, of operation of the framework according to various preferences.

The framework further includes an engine 112. The engine is configured to process the received data, including contextual information 114 associated therewith.

One type of contextual information of the data being received for integration, may reference a particular client to which the data is relevant. Another piece of contextual information may indicate the source of the data (e.g., blog, social network, data harvester, etc.) Another piece of contextual information may indicate the country in which the enterprise and/or data center storing the data is operating, and hence whose laws govern the handling of data to be integrated.

In processing the data, the engine references rules 120 of a rule set. Based upon operation of the rule, the engine determines whether the incoming data is in fact able to be incorporated in compliance with applicable laws, and also possibly the manner of that incorporation.

For example, in certain instances the engine may determine from the data and its associated context, that the data is not subject to any legal requirements. Hence, that incoming data is free to be incorporated in its original form as data 122 stored within a database 124 of the data mart.

In other instances, however, the engine may determine from operation of the rules that the data is indeed subject to legal restrictions, but may be incorporated in a modified form. One example of such modification could comprise rendering the data anonymous.

According to some instances, compliance may be dependent upon obtaining consent of the owner of the information. Under such circumstances, engine may be configured to provide a controlled interaction 142 with the information source (e.g., generate a pop up to solicit consent, followed by storage of acceptance thereof).

In yet another example, the modification could involve substituting certain information. Thus where a data message including a copyrighted and/or trademarked logo of a public social network is sought to be integrated, that data could be modified to include only the name of the public social network before being stored.

In still other instances, the engine may determine from rule operation, that the data is subject to legal restrictions unable to be complied with. In such a situation, incorporation of the data into the data mart, is not permitted.

So far, the discussion of FIG. 1 has focused upon integration of data from a source located external to the user's enterprise. However, embodiments are not limited to such circumstances, and control frameworks according to various embodiments may also handle integration of data received from a source 140 that is located internal to the enterprise.

An example is where the framework governs integration of data within a collaboration tool (e.g., Customer Relationship Management—CRM software), that is separate from other software (e.g., Enterprise Resource Planning—ERP software) also being utilized by the enterprise. In such an environment, the framework can ensure compliance of data received from the ERP software (which may not have been originally stored in a compliant manner), prior to its integration with the CRM software.

It is further noted that utilization of an integration framework in this manner, may desirably serve to enforce compartmentalization restricting the circulation of sensitive information within the enterprise. That is, execution of rules by the context aware engine of the framework can serve to prevent incorporation (e.g., copying, movement, deletion) of confidential data arising from some other source internal to the enterprise.

It is noted that the particular embodiment of FIG. 1 shows the rules referenced by the engine, being stored in a same data mart/database as the data being integrated. This is not required, however, and in alternative embodiments the rules could be stored separate from the incorporated data.

Moreover, the rules referenced by the engine need not be static in nature, and can evolve. The engine may be in feedback communication with the ruleset to grow the rules/Rule Framework accessed data over time, in the manner of a learning system. An example of this could be where the engine learns to modify the rules governing solicitation/storage of consent, based upon previous interactions (e.g., contact information of confirmed accuracy for a particular data owner is acquired and utilized).

It is also noted that FIG. 1 shows the context-aware engine located outside of the data mart. While this is certainly one possible embodiment, alternative embodiments could feature an engine present within the data mart. An example of such an embodiment is where the processing power of an in-memory database engine is sought to be leveraged to perform data integration control task(s).

Control frameworks according to embodiments, may permit the storage and processing of data only if allowed by law (e.g., obligations arising from statute or from contractual provisions). For example, data incorporation may be allowed only where a use license exists.

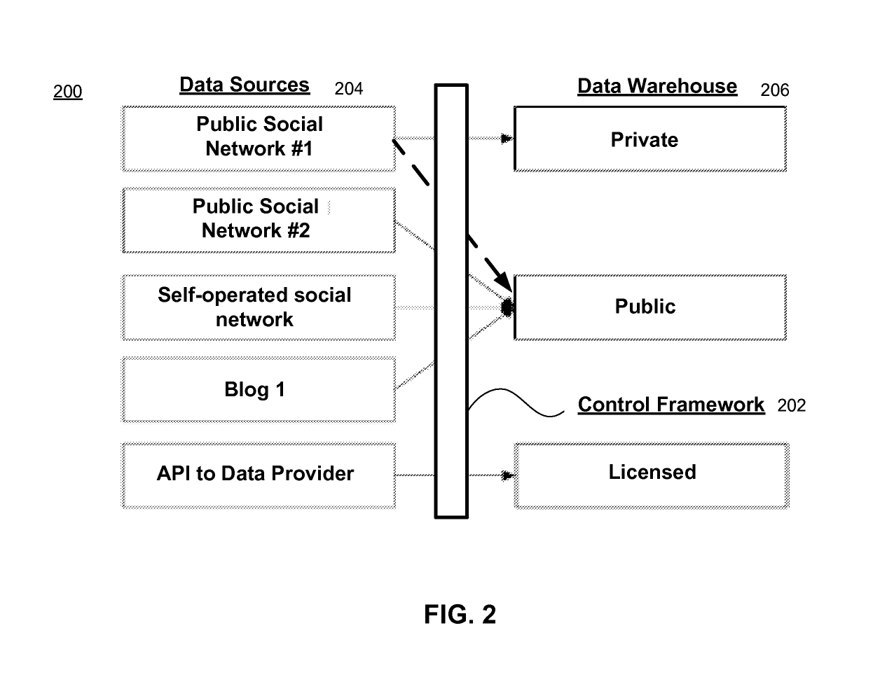

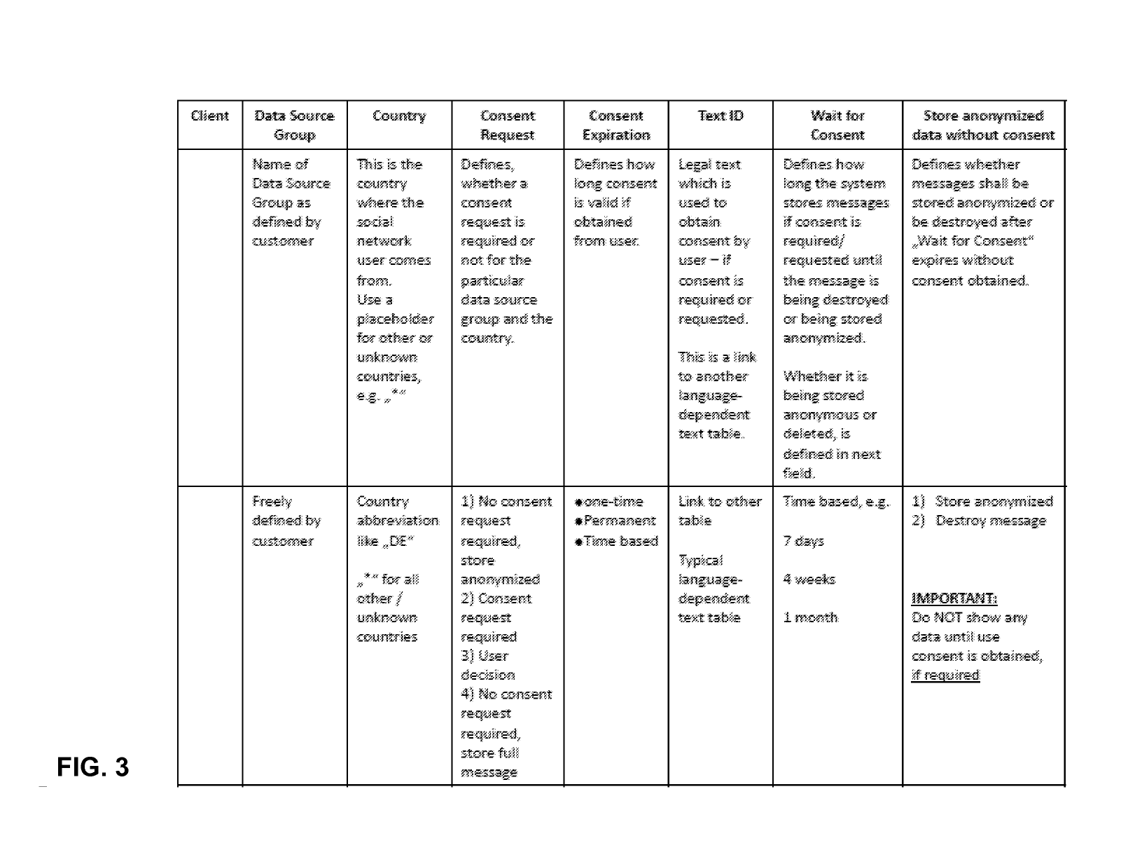

Control frameworks according to embodiments may include features and functions related to data privacy issues. An example is a provision for user consent to the storage and handling of personal data. Such consent is described below in connection with FIGS. 2-3.

Control frameworks according to embodiments may permit management of data over its lifetime. For example, rules may allow a customer to display, change, and/or delete all data being stored for a particular person.

Control frameworks according to embodiments, may implement rules relating to a variety of data integration issues. For example, some rules may relate to general and data privacy requirements, e.g., sharing personal data, data anonymization and consent thereto.

Some rules executed by the control framework may be specifically applicable to certain types of data. For example, the handling of logos of third party entities (e.g., social networks) may be governed by legal regulations such as copyright and trademark, as well as T&Cs of that third party.

Another example of a particular type of data which may be handled by specific rules of the framework, is data available from the Application Programming Interface (API) of third parties responsible for data harvesting activities. Provision of such harvested data may be subject to contractual terms extant between the customer and the third party data harvester.

Further details regarding embodiments of control frameworks fostering compliant integration of data from internal and/or external sources, are now provided in connection with the following example.

### EXAMPLE

One example of a framework for incorporating data in a legally compliant manner from internal and/or external data sources, is now described in the context of data privacy protection. Specifically, FIG. 2 shows a system 200 in which a framework 202 resides between a plurality of data sources 204, and a data warehouse 206 that is configured to store data received therefrom.

In this particular example, the data integration control framework is provided as part of a collaboration tool offered by SAP SE of Walldorf, Germany. However, this is not required, and in various embodiments of the framework may be deployed independent of the respective tool.

Thus, the framework may be configured to handle/supervise the necessary consent regarding an internal tool. As mentioned below, internal as well as external data may be governed by compliance issues (e.g., privacy), and hence the framework is configured to interact with various tools in order to fully perform this role.

As a threshold matter, it is noted that such a data integration framework would likely be deactivated when the software is delivered. A customer could then be required to intentionally activate the framework, using business functions of the collaboration tool.

Moreover, because ultimate responsibility for compliant integration of data rests with the customer (rather than with SAP), a legal disclaimer such as provided below, could be provided at a prominent place within the business function documentation:

“The use of information originating from social networks and other data sources must be checked in the individual case against the background of all applicable laws and regulations (e.g. on data protection) and individual rules (e.g. for the relevant data source). SAP does not accept any liability for the use of the application by its customers.”

The simplified block diagram of FIG. 2 illustrates a plurality of input data from different sources, being integrated in various ways by the control framework. FIG. 2 shows definition of rules to handle a same type of data from different sources, differently. For example, personal information for integration from a public social network may be handled one way (e.g., designated as private). That same personal information to be integrated from another source (e.g., a blog) may be handled in a different manner.

FIG. 2 also shows definition of rules to handle different types of data available from a same source, differently. For example, general data harvested from a public social network may be handled for integration in one manner. Data for the corporate fanpage of that public social network may be handled for integration in a different manner.

FIG. 3 shows one example of a rule for compliant data integration, expressed in a table. This rule governs integration of data in a manner compliant with privacy concerns. Here, the first three columns (Client, Data Source Group, Country) represent a primary key, indicating contextual factors considered in applying the rule to incorporate the data.

While FIG. 3 shows specific names of the data source groups as Public Social Network #1, Blog 1, etc., this is not required. A user is free to define those groups, beneficially imparting flexibility to the application of rules to allow them to handle different types of data (received even from a same source), for integration.

It is to be further understood that additional/different columns may be used to differentiate between incoming data for integration. For example, a column could distinguish between incoming text data, versus data also including shape/logo content.

The remaining columns of the table in FIG. 3 represent consent management configuration for handling personal data compliant with applicable privacy restrictions. Here, where data comprising a message containing personal data is sought to be integrated, this specific rule provides for: storing the full message, storing the message only an anonymous form, or not storing the message absent consent. In certain cases, the data that is integrated may be earmarked for future deletion.

It is noted that integration of data in a manner compliant with privacy regulations (as shown in FIG. 2 and implemented with the specific rule of FIG. 3), represents only one possible application for data integration control frameworks. Various frameworks according to embodiments may include specific rules addressing compliance with issues other than data privacy, including but not limited to:
trademark laws;
copyright laws;
import/export laws;
security regulations;
T&Cs of various social networks; and
other requirements arising from statute and/or contract.

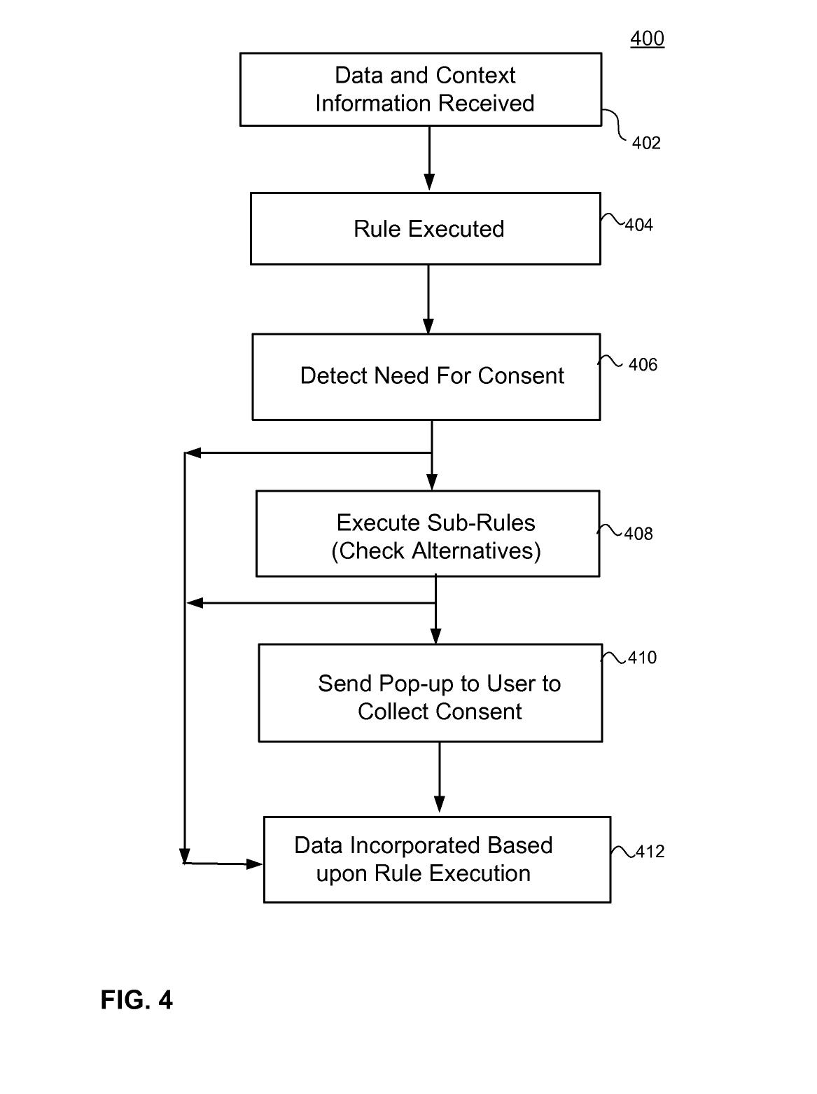

FIG. 4 is a simplified flow diagram showing a method 400 according to an embodiment. In a first step 402, an engine receives an input in the form of data and associated context information.

In a second step 404, the engine executes a rule to process the data and the context information. In a third step 406, the engine detects the need of consent from an information source (e.g., in order to obtain permission to store certain privacy information).

In a fourth step 408, the engine may check sub-rules to check to see if alternatives are available. In a fifth step 410, if necessary the engine sends a pop-up to collect the consent to store the data.

In a sixth step 412, the engine incorporates the data into a storage medium based upon execution of the rule.

Control frameworks according to embodiments may offer one or more benefits over conventional approaches. One potential advantage is a customizing toolkit's allowing flexible adoption and assimilation of different internal and external social tools (e.g., FACEBOOK), as well as recognition of internal dependencies, such as business organization structure/national jurisdiction/business systems in various locales, etc.

A customizing toolkit of the control framework may also allow enterprises to assure and control compliance with local data protection rules

Further, some embodiments allow software vendors to transfer responsibility for compliance over to their customers. This is because coding would route via the toolkit platform and avoid risk of coded non-compliance.

Embodiments may also offer the benefit of easing user interaction. This is because a user would only be concerned with the data privacy issues relevant to specific processes being engaged in.

Embodiments may also offer optimized use of resources. For example, new or changed social network tools being on-boarded, can easily be recognized and integrated. Also, changes to the Application Programming Interfaces (APIs) could be covered/protected via the parallel rule framework feature.

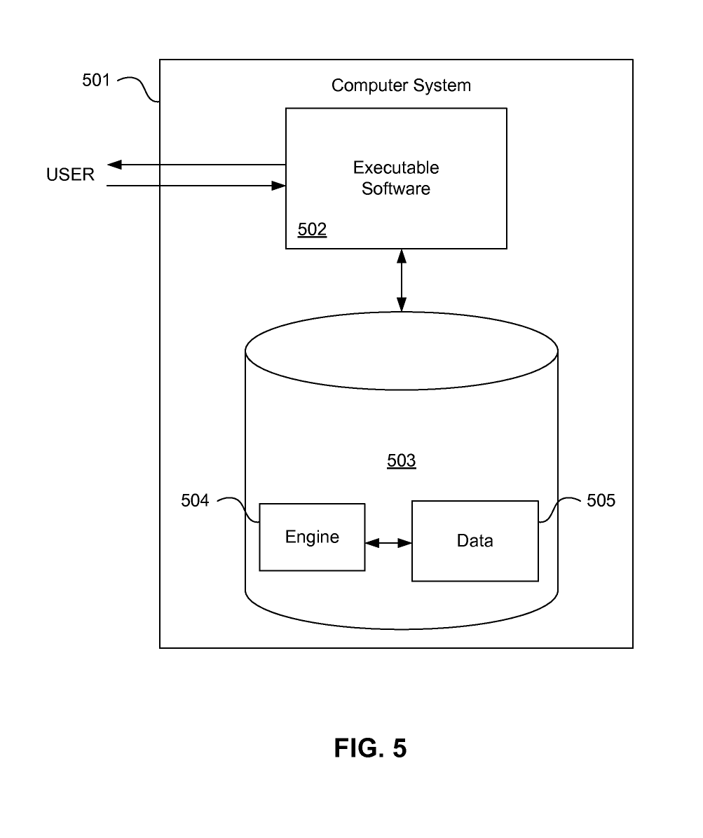

FIG. 5 illustrates hardware of a special purpose computing machine configured to implement a control framework for data integration according to an embodiment. In particular, computer system 501 comprises a processor 502 that is in electronic communication with a non-transitory computer-readable storage medium 503. This computer-readable storage medium has stored thereon code 505 corresponding to a data (internal/external) that is subject to privacy considerations. Code 504 corresponds to an engine. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

It is noted that in the specific embodiment of FIG. 5, the engine is shown as being part of the database. Such an embodiment can correspond to applications performing processing by a powerful engine available as part of an in-memory database (e.g., the HANA in-memory database available from SAP SE of Walldorf, Germany). However this is not required and in certain embodiments the engine may be implemented in other ways, for example as part of an overlying application layer, as is shown in FIG. 1.

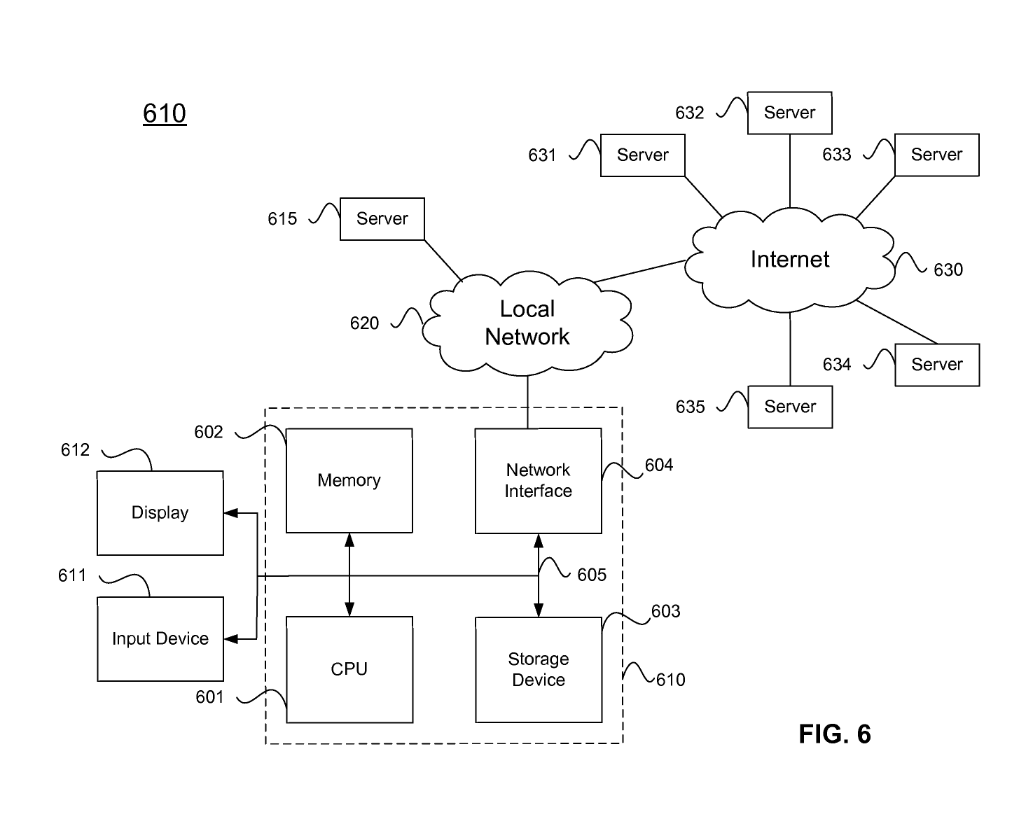

An example computer system 600 is illustrated in FIG. 6. Computer system 610 includes a bus 605 or other communication mechanism for communicating information, and a processor 601 coupled with bus 605 for processing information. Computer system 610 also includes a memory 602 coupled to bus 605 for storing information and instructions to be executed by processor 601, including information and instructions for performing the techniques described above, for example. This memory may also be used for storing variables or other intermediate information during execution of instructions to be executed by processor 601. Possible implementations of this memory may be, but are not limited to, random access memory (RAM), read only memory (ROM), or both. A storage device 603 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 603 may include source code, binary code, or software files for performing the techniques above, for example. Storage device and memory are both examples of computer readable mediums.

Computer system 610 may be coupled via bus 605 to a display 612, such as a cathode ray tube (CRT) or liquid crystal display (LCD), for displaying information to a computer user. This is just an example, and other devices may be utilized as well, such as mobile devices/smart phones/companions (e.g., smart watch, etc.). And particular computer systems in certain embodiments may not include a separate display, e.g., internet of Things (IoT) registered machines' data, and others.

An input device 611 such as a keyboard and/or mouse is coupled to bus 605 for communicating information and command selections from the user to processor 601. In other examples, input may be made via other channels, for example voice recognition utilizing a microphone as an input device. In the context of the IoT, an input could comprise raw or processed data, for example a vibration pattern of a machine.

The combinations of these various components may allow the user to communicate with the system. In some systems, bus 605 may be divided into multiple specialized buses.

Computer system 610 also includes a network interface 604 coupled with bus 605. Network interface 604 may provide two-way data communication between computer system 610 and the local network 620. The network interface 604 may be a digital subscriber line (DSL) or a modem to provide data communication connection over a telephone line, for example. Another example of the network interface is a local area network (LAN) card to provide a data communication connection to a compatible LAN. Wireless links such as WIFI/3G/Universal Mobile Telecommunications Systems (UMTS) and various broadband formats are another example. In any such implementation, network interface 604 sends and receives electrical, electromagnetic, or optical signals that carry digital data streams representing various types of information.

Computer system 610 can send and receive information, including messages or other interface actions, through the network interface 604 across a local network 620, an Intranet, or the Internet 630. For a local network, computer system 610 may communicate with a plurality of other computer machines, such as server 615. Accordingly, computer system 610 and server computer systems represented by server 615 may form a cloud computing network, which may be programmed with processes described herein. In the Internet example, software components or services may reside on multiple different computer systems 610 or servers 631-635 across the network. The processes described above may be implemented on one or more servers, for example. A server 631 may transmit actions or messages from one component, through Internet 630, local network 620, and network interface 604 to a component on computer system 610. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

1. A computer-implemented method comprising:
an engine receiving data and associated contextual information of a data source, from a user within an enterprise;
the engine processing the data and the associated contextual information according to a rule to provide an interaction with the source soliciting a consent to store the data and associated contextual information; and
based upon execution of the rule, the engine receiving the consent from the source and integrating the data for storage within the enterprise compliant with a legal obligation.

2. A method as in claim 1 wherein the data comprises personal data, and the legal obligation relates to privacy.

3. A method as in claim 2 wherein the data is integrated for storage in an anonymous form.

4. A method as in claim 1 wherein the associated contextual information comprises a country, and the legal obligation arises from a law of the country.

5. A method as in claim 1 wherein the associated contextual information comprises a client.

6. A method as in claim 1 wherein the associated contextual information identifies the data source.

7. A method as in claim 6 wherein the source is external to the enterprise.

8. A method as in claim 6 wherein the source is internal to the enterprise.

9. A method as in claim 1 wherein the rule governs modification of the data for integration.

10. A non-transitory computer readable storage medium embodying a computer program for performing a method, said method comprising:
an engine receiving personal data and associated contextual information of a data source, from a user within an enterprise;
the engine processing the personal data of an individual and the associated contextual information according to a rule;
based upon execution of the rule, the engine soliciting from the individual, consent to store the personal data; and
based upon execution of the rule and receipt of the consent from the individual, the engine integrating the personal data for storage within the enterprise compliant with a legal obligation relating to privacy.

11. A non-transitory computer readable storage medium as in claim 10 wherein the rule governs modification of the personal data for integration.

12. A non-transitory computer readable storage medium as in claim 11 wherein the personal data is integrated for storage in an anonymous form.

13. A non-transitory computer readable storage medium as in claim 11 wherein the personal data is integrated earmarked for future deletion.

14. A non-transitory computer readable storage medium as in claim 10 wherein a logo in the personal data is substituted.

15. A non-transitory computer readable storage medium as in claim 10 wherein the associated contextual information is selected from at least one of a client, a country, and the data source.

16. A computer system comprising:
one or more processors;
a software program, executable on said computer system, the software program configured to cause an in-memory database engine to:
receive data and associated contextual information of a data source, from a user within an enterprise;
process the data and the associated contextual information according to a rule to solicit from the source, consent to store the data; and
based upon execution of the rule and receipt of the consent from the source, integrate the data for storage within the enterprise at a data center compliant with a legal obligation arising from a law of a jurisdiction in which the data center resides.

17. A computer system as in claim 16 wherein the data is integrated for storage in an anonymous form.

18. A computer system as in claim 16 wherein the data is integrated earmarked for future deletion.

19. A computer system as in claim 16 wherein the associated contextual information is selected from at least one of a client, a country, and the data source.

20. (canceled)
